(19) United States
(12) Patent Application Publication
(10) Pub. No.: US 2024/0162476 A1
(43) Pub. Date: May 16, 2024

(54) LITHIUM METAL BATTERY

(71) Applicant: Wildcat Discovery Technologies, Inc., San Diego, CA (US)

(72) Inventors: Ye Zhu, San Diego, CA (US); Jinhua Huang, San Diego, CA (US); Gang Cheng, San Diego, CA (US)

(21) Appl. No.: 18/280,876

(22) PCT Filed: Apr. 8, 2022
(86) PCT No.: PCT/US2022/024044

§ 371 Date: Sep. 7, 2023

Related U.S. Application Data
(60) Provisional application No. 63/172,653, filed on Apr. 8, 2021.

(51) Int. Cl. H01M 10/052; H01M 4/38; H01M 10/0568; H01M 10/0569

(52) U.S. Cl. CPC H01M 10/052; H01M 4/382; H01M 10/0568; H01M 10/0569; H01M 2300/0034; H01M 2300/004

(57) ABSTRACT

A battery includes a cathode, a lithium metal anode, and an electrolyte. The electrolyte includes lithium difluoro(oxalato)borate (LiDFOB) salt and a solvent mixture. The solvent mixture includes a first organic solvent having a cyclic carbonate and a second organic solvent having a linear ester or a linear carbonate.

### CROSS-REFERENCE TO RELATED APPLICATION(S)

This application claims priority to and the benefit of U.S. Provisional Patent Application Ser. No. 63/172,653 filed Apr. 8, 2021 the entire disclosure of which is hereby incorporated by reference.

### BACKGROUND

The present invention is in the field of battery technology, and, more particularly, in the area of lithium metal battery cells.

Conventional lithium ion batteries include a positive electrode, or cathode, a negative electrode, or anode, an electrolyte, and typically a separator. The anode in many lithium ion batteries is carbon-based, such as graphite. However, a lithium metal anode can provide several advantages over graphite and other carbon-based anode materials. Lithium metal has very high theoretical specific capacity (3860 mA h g⁻¹), low density (0.59 g cm⁻³) and very low negative electrochemical (e.g., redox) potential (−3.040 V vs. the standard hydrogen electrode). These attributes could enable rechargeable lithium metal batteries to significantly increase the cell-level energy of state-of-the-art lithium ion batteries. However, lithium metal also has several drawbacks that have limited the commercialization of lithium metal batteries. The drawbacks may include high reactivity of lithium metal anode, formation of an unstable solid electrolyte interphase (SEI), growth of lithium dendrites, evolution of inactive lithium during lithium plating and stripping, and/or volume change during battery operation. For example, the dendrites can penetrate the battery separator, resulting in short circuiting of the battery and volatilization of the liquid electrolyte due to increased temperature. Due to these issues, experimentally-tested lithium metal batteries have been observed to have low columbic efficiency (CE), relatively short battery life, safety concerns, and sluggish electrode kinetics.

It may be desirable to provide an electrolyte that can stabilize the lithium metal anode during cycling to overcome the drawbacks associated with lithium metal batteries.

### BRIEF SUMMARY

In one or more embodiments, a battery is provided that includes a cathode, a lithium metal anode, and an electrolyte. The electrolyte has lithium difluoro(oxalato)borate (LiDFOB) salt and a solvent mixture. The solvent mixture includes a first organic solvent having a cyclic carbonate and a second organic solvent having a linear ester or a linear carbonate.

In one or more embodiments, a battery is provided that includes a cathode, a lithium metal anode, and an electrolyte. The cathode includes nickel, manganese, and cobalt. The electrolyte has LiDFOB salt and a solvent mixture. The solvent mixture includes a first organic solvent comprising a cyclic carbonate, a second organic solvent comprising a linear non-fluorinated ester or a linear carbonate, and a third organic solvent comprising a fluorinated ester.

In one or more embodiments, a battery is provided that includes a cathode, a lithium metal anode, and an electrolyte. The electrolyte has LiDFOB salt and a solvent mixture. The LiDFOB salt is present at a concentration from 0.5 M to 1.5 M, and the solvent mixture includes fluoroethylene carbonate (FEC), ethyl methyl carbonate (EMC), and ethyl difluoroacetate.

### BRIEF DESCRIPTION OF THE DRAWINGS

FIG. 1 is a graph showing the discharge capacity over total cycles for multiple lithium metal batteries that have different electrolytes.

FIG. 2 is a graph plotting the cycling performance of six lithium metal batteries formed according to the embodiments disclosed herein.

FIG. 3 is a graph showing synergistic effects of ethyl difluoroacetate when added to the LiDFOB, FEC, and EMC electrolyte according to an embodiment.

FIG. 4 is a graph plotting capacity retention percentage over total cycles for three different lithium metal batteries that differ only in the type of lithium salt present in the electrolyte.

FIG. 5 is a graph plotting capacity retention percentage at the 302^{nd} cycle for multiple different lithium metal batteries formed according to embodiments described herein.

FIG. 6 is a graph plotting discharge capacity over total cycles for multiple lithium metal batteries according to an embodiment that have different cyclic carbonate organic solvents.

FIG. 7 is a graph plotting discharge capacity over total cycles for multiple lithium metal batteries according to an embodiment that have different linear, non-fluorinated esters and carbonates.

FIG. 8 is a graph showing discharge capacity over total cycles for multiple lithium metal batteries that have different ester organic solvents.

### DETAILED DESCRIPTION

The following definitions apply to aspects described with respect to one or more embodiments of the inventive subject matter. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at 30 degrees C., unless the context clearly dictates otherwise.

Ranges presented herein are inclusive of their endpoints. Thus, for example, the range 1 to 3 includes the values 1 and 3 as well as the intermediate values.

Embodiments of the inventive subject matter provide a lithium metal battery. The lithium metal battery includes a cathode, an anode, an electrolyte, and optionally a separator. The electrolyte and the separator are disposed between the cathode and the anode. The lithium metal battery may be a secondary battery, such that the battery is rechargeable. Discharging and charging of the battery may be accomplished by reversible intercalation and de-intercalation of lithium ions into and from the host material of the cathode and plating/stripping of lithium on the anode. The voltage of the battery may be based on redox potentials of the anode and the cathode, where lithium ions are accommodated or released at a lower potential in the former and a higher potential in the latter.

The anode of the lithium metal batteries is composed of lithium metal. The lithium metal may define at least 50% by weight of the anode. The lithium metal may be pure lithium, or at least 95% lithium by weight, at least 97% lithium by weight, at least 99% lithium by weight, or intermediary percentages of lithium by weight. Alternatively, the lithium metal anode may be an alloy of lithium with at least one other metal. For example, the lithium metal anode may be a lithium-indium (Li—In) alloy, a lithium-magnesium (Li—Mg) alloy, a lithium-aluminum (Li—Al) alloy, or the like. In the alloy compositions, the lithium component may represent between about 50 wt. % and about 90 wt. % of the alloy. The other metal or metals may represent about 10 wt. % to about 50 wt. % of the alloy.

In one or more embodiments, the cathode may utilize any suitable intercalation compound such as those known in lithium ion battery art. The intercalation-type cathode materials may include phosphates, fluorophosphates, fluoro sulfates, fluoro silicates, spinels, lithium-rich layered oxides, composite layered oxides, and the like. Further examples of suitable cathode materials include: spinel structure lithium metal oxides, layered structure lithium metal oxides, lithium-rich layered structured lithium metal oxides, lithium metal silicates, lithium metal phosphates, metal fluorides, metal oxides, sulfur, and metal sulfides. Non-limiting examples of specific cathode active materials include lithium cobalt oxide (e.g., LiCoO₂), lithium nickel manganese cobalt oxides (“NMC”), and lithium nickel cobalt aluminum oxides (e.g., LiNi_{0.8}Co_{0.15}Al_{0.05}O₂). The formula for NMC may be LiNiₓMn_{y}Co_{z}O_{w}, where 0<x<1, 0<y<1, 0<z<1, x+y+z=1, and 0<w≤2. NMC cathode materials may include, but are not limited to, electrically active materials containing LiNi_{0.33}Mn_{0.33}Co_{0.33}O₂, LiNi_{0.6}Mn_{0.2}Co_{0.2}O₂ (referred to herein as NMC 622), LiNi_{0.8}Mn_{0.1}Co_{0.1}O₂, and LiNi_{0.5}Mn_{0.3}Co_{0.2}O₂. In an alternative embodiment, the cathode of the lithium metal batteries may include sulfur, for a Li—S battery, or oxygen, for a Li-air battery, as opposed to an intercalation-type material.

The electrolyte of the lithium metal batteries disclosed herein may be any suitable electrolyte such as those known in the art and may be a liquid electrolyte such that the electrolyte has a liquid, gel, other non-solid phase, or combination thereof. Optionally, the liquid electrolyte according to an embodiment may be added to a solid state battery which has a solid electrolyte. Adding the liquid electrolyte to the solid electrolyte could provide enhance the performance of the battery.

The lithium metal batteries disclosed herein may have a specially-formulated electrolyte composition that is designed and experimentally confirmed to stabilize the lithium metal anode during cycling. The electrolyte may include a lithium salt dispersed in a solvent mixture. The lithium salt according to the embodiments disclosed herein is lithium difluoro(oxalato)borate (LiDFOB) salt. The solvent mixture may include at least two organic solvents. For example, the solvent mixture includes a first organic solvent that has a cyclic carbonate, and a second organic solvent that has a linear ester or a linear carbonate. The first organic solvent may desirably have a higher dielectric constant than the second organic solvent. Typically, the dielectric constant of the first organic solvent is at least 10%, 20% or 30% greater than the second organic solvent. The second organic solvent desirably has a lower viscosity than the first organic solvent. Typically, the viscosity of the second organic solvent is at least 10%, 20% or 30% lower than the viscosity of the first organic solvent. In an embodiment, the solvent mixture includes a third organic solvent with the first and second organic solvents. The third organic solvent has a fluorinated ester. The third organic solvent also desirably has a lower viscosity than the first organic solvent in the same fashion as the second organic solvent. In this embodiment, the solvent mixture includes a combination of a cyclic carbonate, a linear (non-fluorinated) ester or carbonate, and a fluorinated ester.

In an embodiment, the cyclic carbonate of the first organic solvent is fluoroethylene carbonate (FEC), trifluoropropylene carbonate (TFPC), or propylene carbonate (PC). FEC is represented by formula (1):

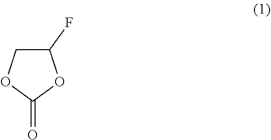

TFPC is represented by formula (2):

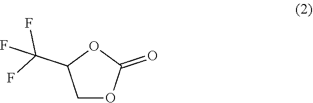

PC is represented by formula (3):

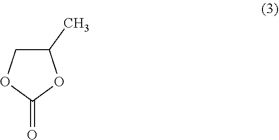

In a non-limiting example, the second organic solvent is a linear carbonate, such as ethyl methyl carbonate (EMC) or diethyl carbonate (DEC). The second organic solvent may be non-fluorinated. EMC is represented by formula (4):

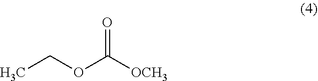

DEC is represented by formula (5):

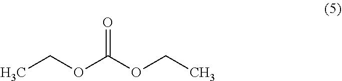

In another non-limiting example, the second organic solvent is a linear carbonate, such as propyl propionate (PP). PP is represented by formula (6):

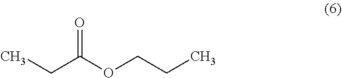

In an embodiment, the fluorinated ester of the third organic solvent is ethyl difluoroacetate (“FAc”) or ethyl fluoroacetate (e.g., ethyl monofluoroacetate). Ethyl difluoroacetate is represented by formula (7):

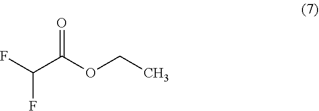

Ethyl fluoroacetate is represented by formula (8):

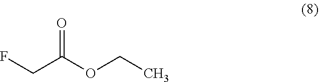

The electrolyte according to a first non-limiting example includes LiDFOB salt in a solvent mixture that combines FEC and EMC. The electrolyte according to a second non-limiting example includes LiDFOB salt in a solvent mixture that combines FEC, EMC, and ethyl difluoroacetate. Each of these electrolyte formulations has experimentally provided superior cycling performance in lithium metal battery cells.

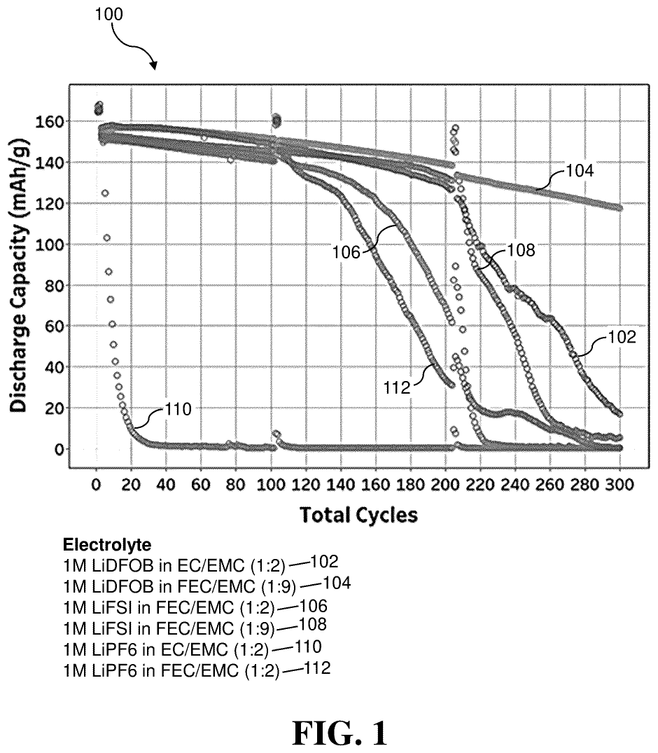

Lithium metal batteries have intrinsic electrochemical differences relative to lithium ion batteries. For example, lithium metal batteries include lithium anodes, and lithium ion batteries typically include carbon-based anodes. Due to these intrinsic differences, electrolyte formulations that stabilize carbon-based anodes in lithium ion batteries are expected to be different from electrolyte formulations that stabilize lithium-based anodes in lithium metal batteries. For example, an electrolyte that includes lithium hexafluorophosphate (LiPF₆) salt, ethylene carbonate (EC) solvent, and ethyl methyl carbonate (EMC) solvent exhibits good performance in lithium ion batteries, but showed very poor cycling performance when applied in lithium metal batteries, as shown in FIG. 1, represented by plot line 110.

The specific electrolyte formulations of the lithium metal batteries disclosed herein were identified and confirmed via experimental testing. For the testing, battery cells were formed in a high purity argon filled glove box (M-Braun, O₂ and humidity content <0.1 ppm). The cathode was NMC 622 (LiNi_{0.6}Mn_{0.2}Co_{0.2}O₂ compound formed into a cathode film. The anode was a 20 micron lithium metal electrode formed into an anode film. Each battery cell included the composite cathode film, a polypropylene separator, and a lithium metal anode film. Electrolyte components were formulated and added to the battery cell, which was then sealed. The formation cycle for NMC 622//Li cells was 12 hours OCV (open circuit voltage) hold, followed by a C/10 charge to 4.3 V with a CV (constant voltage) hold until the charge current was terminated by reaching 0.025 C. Then the cells discharged at C/10 current to 3.0 V at 30° C. The process was repeated twice to complete the formation cycles. Cells were then cycled between 4.3 V and 3 V with 0.33 C charge and 0.67 C discharge cycling rates.

FIG. 1 is a graph 100 showing the discharge capacity over total cycles for multiple exemplary lithium metal batteries that have different electrolytes. Discharge capacity is measured in units of mAh/g. The total cycles refer to charging and discharging cycles. FIG. 1 shows data for six different lithium metal batteries. Each battery has the same anode and cathode, which are the lithium metal anode and the NMC 622 cathode described above. The six tested batteries differ only in the composition of the electrolyte, so the variation in discharge capacity over total cycles is attributable to the different electrolytes.

The exemplary electrolyte of a first battery, represented by plot line 102, includes 1 M LiDFOB salt in a solvent mixture of ethylene carbonate (EC) and EMC at an EC:EMC ratio of 1:2 by volume. This battery composition proved to have the second-best cycle performance of the six test batteries. The discharge capacity is second-highest of the tested batteries from cycle 220 through cycle 300.

The exemplary electrolyte of a second battery, represented by plot line 104, includes 1 M LiDFOB salt in a solvent mixture of FEC and EMC at a FEC:EMC ratio of 1:9 by volume. This second electrolyte differs from the electrolyte of the first battery 102 by substituting EC with FEC and increasing the amount of EMC relative to the amount of FEC. FIG. 1 indicates that this battery 104 performed the best of the six tested batteries. For example, there was no significant drop off in the capacity at a specific cycle. The discharge capacity slowly decreased over the cycles. Even at the 300^{th} cycle, the capacity was still at about 75% of the initial capacity.

The electrolyte of a third battery, represented by plot line 106, includes 1 M lithium bis(fluorosulfonyl)imide (LiFSI) salt in a solvent mixture of FEC and EMC at a FEC:EMC ratio of 1:2 by volume. The third battery 106 performed fourth-best of the six batteries, as the capacity dropped significantly before the 200^{th} cycle.

The electrolyte of a fourth battery, represented by plot line 108, includes 1 M LiFSI salt in a solvent mixture of FEC and EMC at a FEC:EMC ratio of 1:9 by volume. The only different between the third battery 106 and this fourth battery 108 is in the relative amounts of FEC and EMC in the solvent. This fourth battery 108 differs from the best-performing second battery 104 only in the choice of salt. As shown in FIG. 1, the fourth battery 108 performs third-best of the six batteries (e.g., better than the third battery 106). The discharge capacity is a little less than the capacity of the second battery 104 during the first 200 cycles, but then the capacity of the fourth battery 108 drops substantially from about cycle 210 to cycle 260.

The electrolyte of a fifth battery, represented by plot line 110, includes 1 M LiPF₆ salt in a solvent mixture of ethylene carbonate (EC) and EMC at a EC:EMC ratio of 1:2 by volume. This electrolyte composition is typically used in conventional lithium ion batteries that have carbon-based anodes. Although this electrolyte formulation performs well in some lithium ion batteries, the data in FIG. 1 indicates that this electrolyte formulation exhibits very poor performance with a lithium-based anode in a lithium metal battery. For example, this conventional LiPF₆/carbonate-based electrolyte can only be cycled for a few cycles before reaching 80% capacity retention, and the discharge capacity diminishes almost entirely before 20 cycles. This electrolyte was the worst-performing electrolyte of the six tested. This battery only differed from the first battery 102 in the specific salt present, yet the first battery performed much better than the fifth battery at cycling capacity retention.

The electrolyte of a sixth battery, represented by plot line 112, includes 1 M LiPF₆ salt in a solvent mixture of FEC and EMC at a FEC:EMC ratio of 1:2 by volume. This sixth electrolyte only differs from the electrolyte of the fifth battery 110 by substituting EC with FEC. As shown in FIG. 1, the sixth battery 112 performs much better than the fifth battery 110 but performs worse than the four other batteries tested. For example, the discharge capacity of the sixth battery 112 starts to drop at about the 100^{th} cycle, and drops at a quicker rate than the other four batteries.

FIG. 1 shows that performance was unpredictable, even though the salts and organic solvents in the tested electrolytes are generally known. For example, the fifth battery 110 had a specific electrolyte formulation that performs well with a graphite-based anode in a lithium ion battery, but exhibited the worst performance of the six when used with a lithium-based anode in a lithium metal battery. Due to unpredictability in the art, there is no expectation that a specific electrolyte formulations can perform similarly with different types of battery chemistries.

The data in FIG. 1 indicates that the best electrolyte formulation of the six tested batteries includes the LiDFOB salt with FEC and EMC, as shown in the second battery 104. The fact that the two best performing batteries, 104 and 102, both had LiDFOB salt suggests that LiDFOB is a better salt than LiPF₆ and LiFSI in these battery compositions. However, the specific solvent combinations also affected the battery performance, as indicated by the fact that the FEC/EMC solvent mixture of the second battery 104 yielded significantly better performance than the EC/EMC solvent mixture of the first battery 102. Further evidence that the FEC/EMC solvent mixture is superior to the EC/EMC solvent mixture is that the fourth battery 108, which had FEC/EMC but lacked LiDFOB, performed third-best.

The organic solvent EMC was included in the electrolytes of all six batteries tested in FIG. 1. The lower viscosity EMC facilitates the dissolution of the lithium salt and promotes transport of the lithium ions in the formulation. For example, battery cells with 1M LiDFOB in FEC, but lacking EMC, are not be able to be cycled at all due to high cell resistance.

Table 1 compares cycling performance of multiple different lithium metal batteries that have different amounts of LiDFOB salt, FEC solvent, and EMC solvent. For example, after identifying the LiDFOB with FEC/EMC solvent mixture as a preferred electrolyte, experimental batteries were constructed with different concentrations of LiDFOB and different ratios of FEC to EMC (e.g., different FEC:EMC ratios). The concentrations of the LiDFOB tested included 0.6 M, 0.8 M, 1.0 M, 1.2 M, 1.4 M, and 2M. The FEC:EMC ratios tested included 1:2, 1:4, 1:5, 1:6, 1:7, 1:8, 1:9, 1:11, 1:13, and 3:97 by vol. The performance was evaluated by determining the specific discharge cycle number at which the discharge capacity of each battery reached 80% of the initial capacity level. The 80% capacity threshold may be used as an end of cycle decision point when evaluating lithium metal batteries. The cycling was at 4.3-3 V. In Table 1, better-performing batteries reached the 80% capacity threshold at later cycles than worse-performing batteries, such that larger numbers are preferred.

TABLE 1
Cycle Number to Reach 80% Capacity Retention (at 4.3 V charge voltage).
FEC/EMC Ratio

| | | [LiDFOB] | | | | | | | | | |
|---|---|---|---|---|---|---|---|---|---|---|---|
| | | 1:2 | 1:4 | 1:5 | 1:6 | 1:7 | 1:8 | 1:9 | 1:11 | 1:13 | 3:97 |
| | | (33%) | (20%) | (17%) | (14%) | (12.5%) | (11.1%) | (10%) | (8.3%) | (7%) | (3%) |
| 0.6 | M | | | | 84 | | | 133 | | 246 | |
| 0.8 | M | | | | 104 | | | 247 | | 298 | |
| 1 | M | 32 | 87 | 182 | 145 | 278 | 230 | 254 | 230 | 264 | 5 |
| 1.2 | M | | | | 232 | | | 312 | | 235 | |
| 1.4 | M | | | | 225 | | | 241 | | 165 | |
| 2 | M | | | | 110 | | | 81 | | 57 | |

Table 1 indicates that the best electrolyte formulation of the tested formulations had 1.2 M LiDFOB and a FEC/EMC ratio of 1:9, which did not reach 80% capacity until the 312^{th} cycle. In general, good performance was achieved at concentrations of LiDFOB from 0.6 M to 1.4 M, and at solvent ratios from 1:5 to 1:13. More preferred ranges based on the experimental data include concentrations of LiDFOB from 0.8 M to 1.2 M and FEC/EMC ratios from 1:7 to 1:13.

The data in Table 1 shows that the cycling performance of the lithium metal battery is sensitive to the relative ratio of the three electrolyte components. A preferred concentration of the salt is affected by the ratio of FEC to EMC, and vice-versa. For example, when the FEC/EMC ratio is at the higher levels (e.g., 1:5, 1:6, etc.), higher concentrations of LiDFOB are preferred. When the FEC/EMC ratio is at the lower levels (e.g., 1:9, 1:11, 1:13, etc.), lower concentrations of LiDFOB are preferred. The best performing electrolyte having a FEC/EMC ratio of 1:6 was a battery with 1.2 M LiDFOB, which provided 232 cycles before reaching the 80% threshold. The best performing electrolyte having an FEC/EMC ratio of 1:13 was a battery with 0.8 M LiDFOB, which did not reach the 80% threshold until the 298^{th} cycle. Thus, preferred formulations that include greater relative amounts of FEC generally correspond to greater concentrations of the LiDFOB salt, within certain limits. For example, concentrations of the LiDFOB above 2 M may not be preferred.

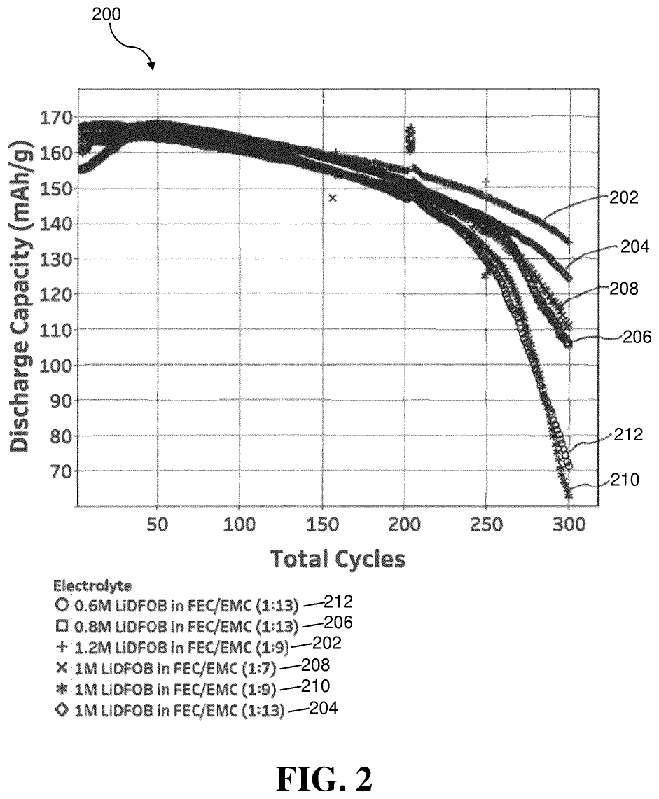

FIG. 2 is a graph 200 plotting the cycling performance of six lithium metal batteries formed according to the embodiments disclosed herein. The cycling performance is evaluated by capacity retention percentage over total cycles. Each of the six tested batteries includes an electrolyte that has LiDFOB salt in a solvent mixture of FEC and EMC. The six tested batteries differ only in the concentration of the LiDFOB salt and/or the FEC/EMC ratio.

The electrolyte of the best-performing battery, represented by plot line 202, of the tested compositions had 1.2 M LiDFOB and a FEC/EMC ratio of 1:9. This battery formulation resulted in 312 cycles before reaching the 80% threshold as shown in Table 1. The plot line 204 in FIG. 2 represents an electrolyte with 1 M LiDFOB and a FEC/EMC ratio of 1:13. The plot line 206 represents an electrolyte with 0.8 M LiDFOB and a FEC/EMC ratio of 1:13. The plot line 208 represents an electrolyte with 1 M LiDFOB and a FEC/EMC ratio of 1:7. The plot line 210 represents an electrolyte with 1 M LiDFOB and a FEC/EMC ratio of 1:9, which matches the electrolyte of the fourth battery 108 in FIG. 1. The plot line 212 represents an electrolyte with 0.6 M LiDFOB and a FEC/EMC ratio of 1:13. The graph 200 indicates that all six batteries retained over 80% discharge capacity until at least the 240^{th} cycle. All six batteries with the LiDFOB, FEC, and EMC combination in FIG. 2 performed significantly better than the first, third, fourth, fifth, and sixth test batteries 102, 106, 108, 110, 112 in FIG. 1, which lacked that specific combination.

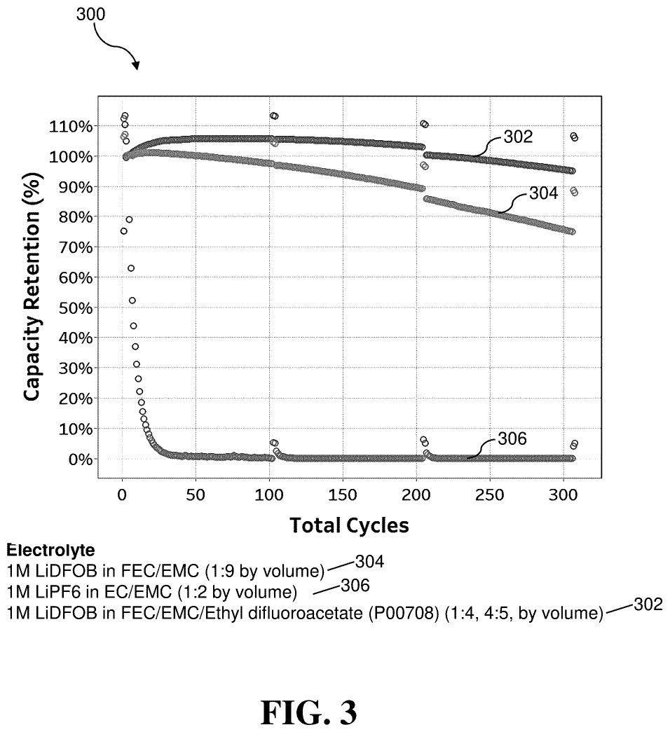

In an embodiment, the electrolyte of the lithium metal battery also includes a third organic solvent that has a fluorinated ester. For example, the third organic solvent may be ethyl difluoroacetate (“FAc”) or ethyl fluoroacetate. FIG. 3 is a graph 300 showing synergistic effects of ethyl difluoroacetate when added to the LiDFOB, FEC, and EMC electrolyte according to an embodiment. The graph 300 of FIG. 3 plots cycling performance of three different electrolytes evaluated by capacity retention percentage over total cycles. The first electrolyte, represented by plot line 302, includes 1 M LiDFOB in a solvent mixture of FEC, EMC, and ethyl difluoroacetate (FAc). The volume ratio of the organic solvents FEC:EMC:FAc is 1:4.5:4.5 in the first electrolyte. The second electrolyte, shown as plot line 304, is the same as the first electrolyte except for lacking the ethyl difluoroacetate. For example, the second electrolyte has 1 M LiDFOB in a solvent mixture of FEC and EMC at a FEC:EMC ratio of 1:9. The first electrolyte can be made by duplicating the second electrolyte except for replacing half of the EMC in the second electrolyte with ethyl difluoroacetate. The third electrolyte, represented by plot line 306, is a base or reference formulation that has 1 M LiPF₆ in EC and EMC at a ratio of 1:2. The third electrolyte may be the same as the electrolyte represented by the plot line 110 shown in FIG. 1.

The ethyl difluoroacetate was found to show great synergy when combined with the LiDFOB/FEC/EMC electrolyte. FIG. 3 demonstrates that partial substitution of EMC with a fluorinated ester such as ethyl difluoroacetate can further improve the electrolyte performance relative to an electrolyte that lacks the fluorinated ester.

The LiDFOB may have poor solubility in FEC and ethyl difluoroacetate solvent mixture, but the EMC facilitates the dissolution of the LiDFOB. In a preferred embodiment, the amount of EMC present is no less than the amount of ethyl difluoroacetate by volume or weight. Furthermore, the EMC and the ethyl difluoroacetate may be present at respective amounts that are at least three times the amount of FEC present by volume or weight. In the tested example electrolyte 302, each of the EMC and the ethyl difluoroacetate were present at 4.5 times the amount of the FEC present by volume.

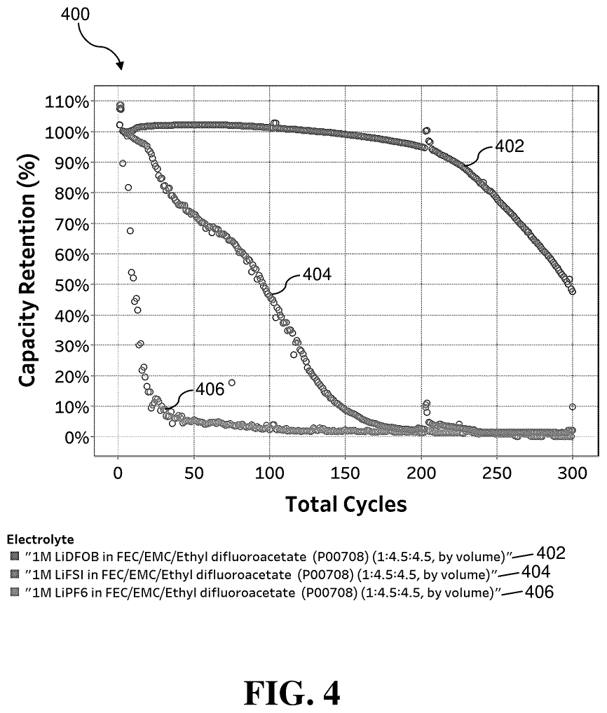

FIG. 4 is a graph 400 plotting capacity retention percentage over total cycles for three different lithium metal batteries that differ only in the type of lithium salt present in the electrolyte. For example, all three tested batteries include the same solvent mixture of FEC, EMC, and ethyl difluoroacetate. The ratio of the organic solvents, according to FEC:EMC:FAc, was 1:4.5:4.5 by volume. The anodes, cathodes, and separators used were the same. The anodes were lithium metal and the cathodes were NMC 622. The first battery, represented by plot line 402, had LiDFOB salt at a concentration of 1 M. The second battery, represented by plot line 404, had LiFSI salt at the 1 M concentration. The third battery, represented by plot line 406, had LiPF₆ salt at the 1 M concentration.

The graph 400 shows that the first battery 402 performed well, maintaining at least 80% capacity until about the 240^{th} cycle. The second and third batteries 404, 406 performed significantly worse than the first battery 402. The capacity of the second battery 404 dropped below 80% before about the 40^{th} cycle, and the capacity of the third battery 406 lost capacity even more drastically than the second battery 404. This data suggests that LiDFOB is synergistic with the FEC/EMC/FAc solvent mixture that is not exhibited by either LiFSI or LiPF₆ with the same solvent mixture.

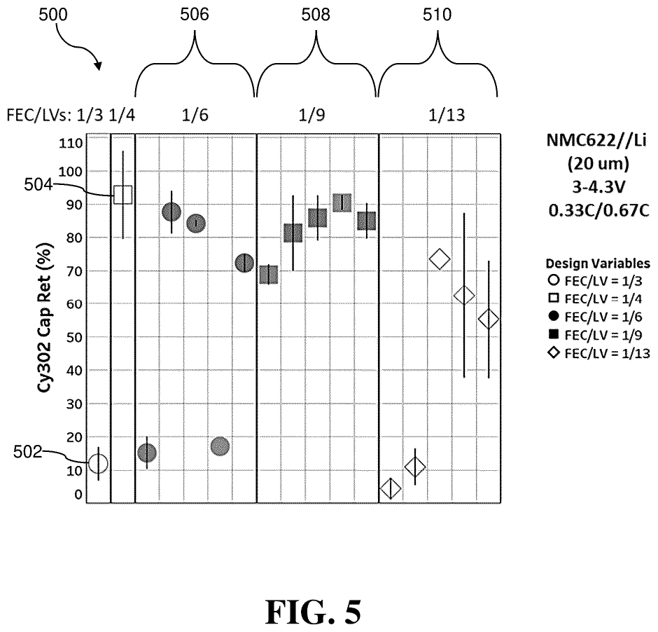

FIG. 5 is a graph 500 plotting capacity retention percentage at the 302^{nd} cycle for multiple different lithium metal batteries formed according to embodiments described herein. For example, each of the tested lithium metal batteries in FIG. 5 has an electrolyte with LiDFOB salt and a solvent mixture including FEC, EMC, and ethyl difluoroacetate (FAc). The tested batteries only differed in the relative amounts or ratios of the FEC, EMC, and FAc solvents by volume. The EMC and the FAc are low viscosity (LV) solvents (e.g., viscosity of less than about 1 cP at 25 degrees C.). The “FEC/LVs” indicator in FIG. 5 refers to the ratio of FEC to a combined amount of the EMC and the FAc (e.g., FEC:[EMC+FAc]). A first battery 502 has an FEC/LV ratio of 1:3. A second battery 504 has an FEC/LV ratio of 1:4. A third set 506 of batteries has an FEC/LV ratio of 1:6. A fourth set 508 of batteries has an FEC/LV ratio of 1:9, and a fifth set 510 has an FEC/LV ratio of 1:13.

The batteries in each of the third, fourth, and fifth sets 506, 508, 510 differ from one another in the relative amount of EMC and FAc. For example, the “EMC/FAc” indicator refers to the ratio of EMC to FAc by volume. The tested EMC:FAc ratios includes 1:3 (e.g., three times more FAc than EMC), 1:2, 1:1 (e.g., equal parts), 2:1, and 3:1 (e.g., three times more EMC than FAc).

The data in FIG. 5 indicates that there is an interdependency between the solvent components, such that varying the amount of one component affects the preferred amount of another component that would provide better capacity retention. More specifically, the data indicates that the FEC/LV ratio (e.g., FEC: [EMC+FAc]) of 1:9 generally performed better than the other tested FEC/LV ratios. For example, compositions with 1:9 FEC/LV and EMC/FAc ratios 1:2, 1:1, 2:1, and 3:1 all demonstrated high capacity retention over 80% at the 302^{nd} cycle. Two other preferred compositions had an FEC/LV ratio of 1:6 and EMC/FAc ratios 1:2 and 1:1, as both compositions also showed over 80% capacity retention at the 302^{nd} cycle. The preferred EMC:FAc ratio actually depends on which FEC/LV ratio is used. For example, the composition with the highest capacity retention had an FEC/LV ratio of 1:9 and an EMC/FAc ratio of 2:1, while the second-best composition had an FEC/LV ratio of 1:6 and an EMC/FAc ratio of 1:2. Due to the strong interdependency among the components, the optimal composition for this ternary solvent mixture is difficult to predict.

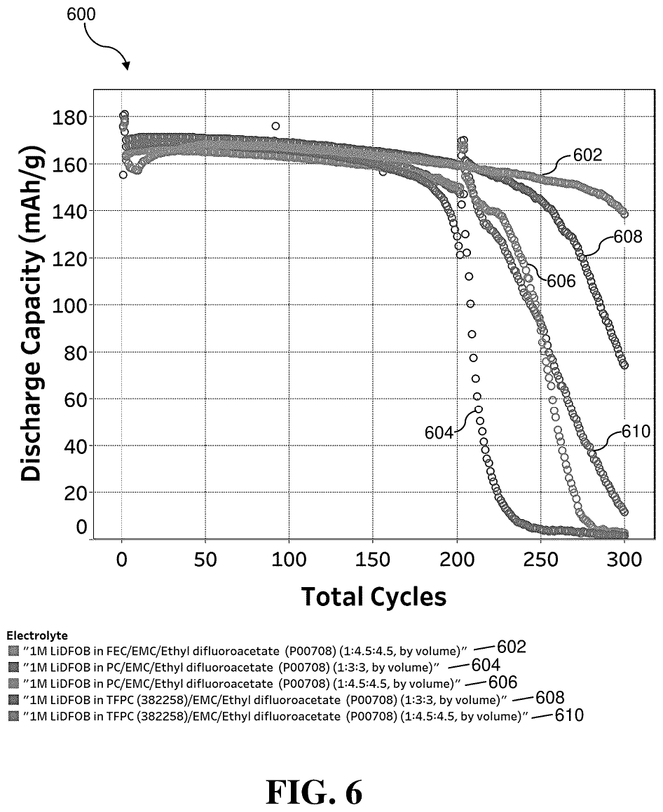

FIG. 6 is a graph 600 plotting discharge capacity over total cycles for multiple lithium metal batteries according to an embodiment that have different cyclic carbonate organic solvents. Each of the tested batteries has the same anode and cathode, and the electrolytes have 1 M LiDFOB salt and include both EMC and ethyl difluoroacetate. The batteries differ in the type of cyclic carbonate organic solvent in the electrolyte and/or the relative amounts of the solvents. For example, a first battery, represented by plot line 602, includes FEC as the cyclic carbonate and the FEC:EMC:FAc ratio is 1:4.5:4.5 by volume. This first battery 602 is the same as the battery 402 in FIG. 4. A second battery, represented by plot line 604, includes propylene carbonate (PC) as the cyclic carbonate and the ratio of PC:EMC:FAc is 1:3:3. A third battery, represented by plot line 606, includes the PC like the second battery, but the ratio of PC:EMC:FAc is 1:4.5:4.5. A fourth battery having plot line 608 includes TFPC as the cyclic carbonate, and the TFPC:EMC:FAc ratio is 1:3:3. A fifth battery with plot line 610 has the TFPC, but the ratio is 1:4.5:4.5.

In FIG. 6, the first battery 602 with the FEC performed better than the batteries with PC and TFPC. However, even the four other batteries 606, 606, 608, 610 that have PC or TFPC instead of FEC as the high dielectric (HD) solvent demonstrated improved cycling performance over a conventional electrolyte with 1 M LiPF₆ salt in an EC and EMC solvent mixture (e.g., battery 110 in FIG. 1). FIG. 6 indicates that a cyclic carbonate like PC and TFPC can be used as a HD solvent in the electrolyte formulations according to one or more embodiments (e.g., instead of FEC), although FEC is the preferred HD solvent.

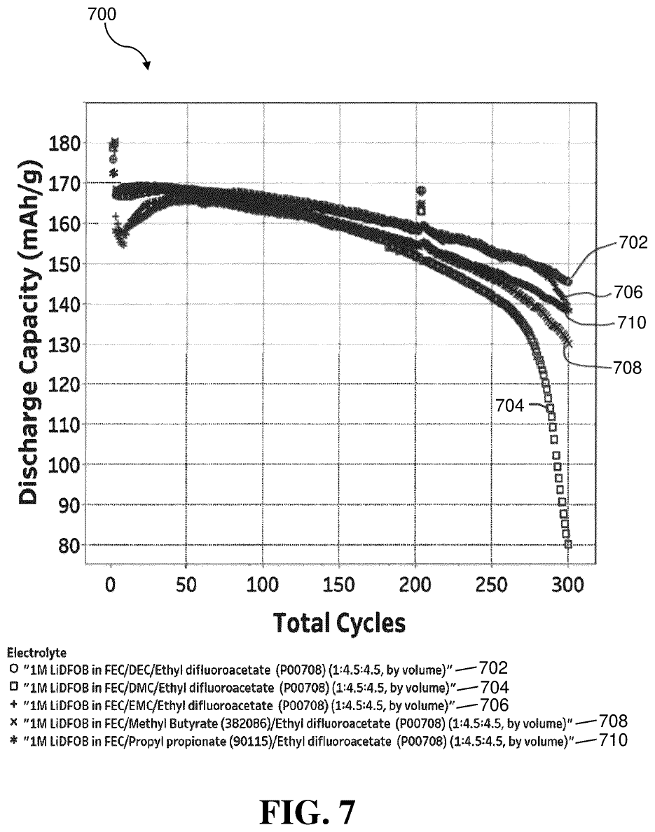

FIG. 7 is a graph 700 plotting discharge capacity over total cycles for multiple lithium metal batteries according to an embodiment that have different linear, non-fluorinated esters and carbonates. Each of the tested batteries has the same anode and cathode, and the electrolytes have 1 M LiDFOB salt and include both FEC and ethyl difluoroacetate. The relative solvent ratios are also the same for the different tested batteries, such that the only difference is the type of low viscosity (LV) linear, non-fluorinated ester or carbonate in the electrolyte. The tested batteries show similar performance until about the 200^{th} cycle. The plot line 702 represents a first battery that includes diethyl carbonate (DEC). The plot line 704 represents a second battery that includes dimethyl carbonate (DMC). The plot line 706 represents a third battery that includes EMC. The plot line 708 represents a fourth battery that includes methyl butyrate (MB). The plot line 710 represents a fifth battery that includes propyl propionate (PP).

The data in FIG. 7 shows that similar performance could be achieved by replacing EMC with another linear, non-fluorinated ester or carbonate. In a non-limiting example, the EMC could be replaced with DEC or PP, which actually demonstrated improved capacity over the EMC at cycles above about 300.

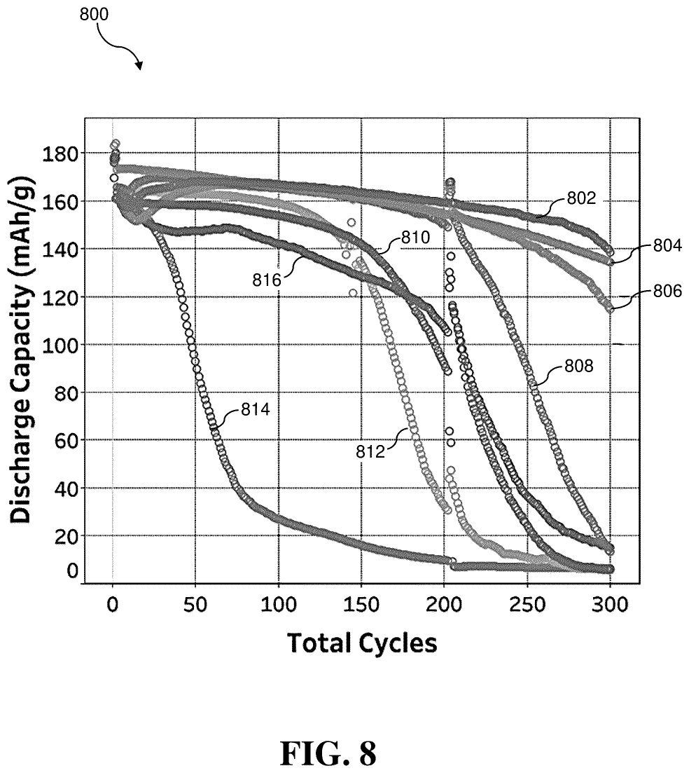

FIG. 8 is a graph 800 showing discharge capacity over total cycles for multiple lithium metal batteries that have different ester organic solvents. Eight different esters were tested and the variation of the ester structure impacted the cycling. The battery with the ethyl difluoroacetate (FAc) represented by plot line 802 performed best of the tested batteries, followed by the battery with ethyl fluoroacetate represented by plot line 804. This indicates that partial fluorine substitution on the alkyl chain of the carbonyl side showed beneficial effects. Both FAc and mono-FAc showed better performance than ethyl acetate represented by plot line 806. However, full fluorine substitution using the solvent ethyl trifluoroacetate represented by plot line 816 performed poorly. Fluorine substitution on the alkyl chain in the ester side (—OR) did not work well, as shown by the relatively poor performance of the solvent 2,2-difluoroethyl acetate represented by plot line 810. Bromine substitution, as shown by the performance of ethyl bromofluoroacetate represented in plot line 814 and chlorine substitution as shown by the performance of ethyl chlorofluoroacetate represented in plot line 812 also did not perform well. Finally, methyl difluoroacetate (methyl 2,2-dofluoroacetate) displays the fourth best performance, but significantly less than ethyl fluoroacetate (ethyl 2,2-difluoroacetate), indicating that the alkyl substituted on the ether oxygen of the fluoroacetate may desirably be, for example, an alkyl difluoroacetate, wherein the alkyl has 2 or more carbons to any useful amount of carbons such as 18, 16, 12, 8, 6, 4 or 3.

The experimental data indicates that an electrolyte composed of LiDFOB salt in a solvent mixture of HD/LV1/LV2 can provide increased discharge capacity over cycling in lithium metal batteries relative to other electrolyte compositions. The HD is a first organic solvent that includes a cyclic carbonate. The cyclic carbonate may be FEC, TFPC, or PC. The cyclic carbonate may be present at a concentration from 5% to 20% by volume of the electrolyte. The LV1 is a second organic solvent that includes a linear, non-fluorinated ester or carbonate, such as EMC, DEC, PP, or MB. The LV2 is a third organic solvent that includes a fluorinated ester, such as ethyl difluoroacetate or ethyl fluoroacetate. The second and third organic solvents can each be present at a concentration from 20% to 80% by volume of the electrolyte.

The embodiments described herein include electrolyte formulations for use with secondary batteries that have lithium metal anodes. The electrolyte formulations include LiDFOB salt and a solvent mixture, where the solvent mixture includes at least a cyclic carbonate and a linear ester or linear carbonate. In at least one embodiment, the cyclic carbonate is FEC and the linear ester or carbonate is EMC, DEC, or PP. In one or more embodiments, the solvent mixture is HD/LV1/LV2, with a high dielectric constant cyclic carbonate and two low viscosity (LV) solvents. One of the LV solvents may include FAc. The embodiments disclosed herein have been experimentally observed to increase the cycle life of lithium metal batteries.

As used herein, value modifiers such as “about,” “substantially,” and “approximately” inserted before a numerical value indicate that the value can represent other values within a designated threshold range above and/or below the specified value, such as values within 5%, 10%, or 15% of the specified value.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A battery comprising:
an intercalation cathode;
a lithium metal anode; and
an electrolyte comprising lithium difluoro(oxalato)borate (LiDFOB) salt and a solvent mixture, the solvent mixture comprising:
a first organic solvent comprising a cyclic carbonate; and
a second organic solvent comprising a linear ester or a nonfluorinated linear carbonate, wherein the LiDFOB salt is present at a concentration from 0.6 M to 1.5 M and the first organic solvent and second organic solvent are present in the electrolyte at a ratio of first organic solvent/second organic solvent from 1:7 to 1:13 by volume.

2. (canceled)

3. The battery of claim 2, wherein the LiDFOB salt is present at a concentration from 0.8 M to 1.2M.

4. The battery of claim 1, wherein the second organic solvent comprises one of ethyl methyl carbonate (EMC), diethyl carbonate (DEC), or propyl propionate (PP).

5. The battery of claim 1, wherein the first organic solvent comprises one of fluoroethylene carbonate (FEC), trifluoropropylene carbonate (TFPC), or propylene carbonate (PC).

6. The battery of claim 1, wherein the ratio of first organic solvent/second organic solvent is 1:9.

7. The battery of claim 1, wherein the first organic solvent comprises FEC, and the second organic solvent comprises EMC.

8. (canceled)

9. The battery of claim 1, further comprising a third organic solvent comprising a fluorinated ester.

10. The battery of claim 9, wherein the third organic solvent comprises one of ethyl difluoroacetate or ethyl fluoroacetate.

11. The battery of claim 9, wherein the first organic solvent comprises FEC, the second organic solvent comprises EMC, and the third organic solvent comprises ethyl difluoroacetate.

12. The battery of claim 1, wherein the lithium metal anode is comprised of at least 50% lithium by weight.

13. A battery comprising:
a cathode comprising nickel, manganese, and cobalt;
a lithium metal anode; and
an electrolyte comprising LiDFOB salt and a solvent mixture, the solvent mixture comprising:
a first organic solvent comprising a cyclic carbonate;
a second organic solvent comprising a linear non-fluorinated ester or a linear carbonate; and
a third organic solvent comprising a fluorinated ester.

14. The battery of claim 13, wherein the second and third organic solvents are each present in the electrolyte at an amount that is more than three times the amount of the first organic solvent by volume.

15. The battery of claim 13, wherein the LiDFOB salt is present at a concentration from 0.5 M to 1.5 M.

16. The battery of claim 13, wherein the first organic solvent comprises one of FEC, TFPC, or PC; the second organic solvent comprises one of EMC, DEC, or PP; and the third organic solvent comprises one of ethyl difluoroacetate or ethyl fluoroacetate.

17. (canceled)

18. (canceled)

19. A battery comprising:
a cathode;
a lithium metal anode; and
an electrolyte comprising LiDFOB salt and a solvent mixture, wherein the LiDFOB salt is present at a concentration from 0.5 M to 1.5 M, and the solvent mixture comprises FEC, EMC, and ethyl difluoroacetate.

20. The battery of claim 19, wherein the lithium metal anode is comprised of at least 50% lithium by weight.

21. The battery of claim 19, wherein the LiDFOB salt is present at a concentration from 0.8 M to 1.2M.

22. The battery of claim 19, wherein the FEC, EMC and ethyl difluoroacetate are present in amounts where FEC/(EMC and ethyl difluoracetate) ratio is 1/6 to 1/13 by volume and EMC/ethyl difluorate ratio by volume is ½ to 2.
